(19) United States
(12) Patent Application Publication
(10) Pub. No.: US 2026/0200800 A1
(43) Pub. Date: Jul. 16, 2026

(54) DVC FOR A SMELTING FURNACE LINING

(71) Applicant: SAINT-GOBAIN CENTRE DE RECHERCHES ET D'ETUDES EUROPEEN, COURBEVOIE (FR)

(72) Inventors: Najih BOUMAHDI, CAVAILLON CEDEX (FR); Thibault CHAMPION, CAVAILLON CEDEX (FR); Léna ROUMIGUIER, CAVAILLON CEDEX (FR)

(21) Appl. No.: 19/138,309

(22) PCT Filed: Dec. 15, 2023
(86) PCT No.: PCT/EP2023/086214

§ 371 Date: Jun. 12, 2025

(30) Foreign Application Priority Data
Dec. 15, 2022 (FR) FR2213444

(51) Int. Cl. C04B 28/34; B28B 11/24; C04B 14/04; C04B 14/30; C04B 22/00; C04B 111/00; C04B 111/28; F27D 1/04

(52) U.S. Cl. CPC C04B 28/344; C04B 14/041; C04B 14/303; C04B 22/0013; F27D 1/04; B28B 11/243; C04B 2111/00431; C04B 2111/28

(57) ABSTRACT

A pulverulent mixture for producing a protective lining of a metal smelting furnace is provided, where the mixture has, for a total of 100% and as weight percentages on the basis of the weight of the mixture, less than 1% by weight of water, and a group of particles distributed between an aggregate fraction and a matrix fraction. The whole of the matrix fraction and of the liquid has a heat-activated binder. The heat-activated binder preferably has a phosphate selected from phosphates devoid of sodium, potassium, and lithium, referred to as a “non-alkali metal phosphate”. The chemical composition of the whole of the matrix fraction and of the liquid is 0.5%<P₂O₅<5% and Na₂O+K₂O+Li₂O<1.0%, as weight percentages based on the weight of said mixture.

### TECHNICAL FIELD

The invention relates to a dry powder mix of the dry ramming mix type, hereinafter referred to as DVC (dry vibratable mix or dry refractory). A DVC according to the invention is particularly intended for the manufacture of a furnace lining, for example a lining of an induction furnace or an arc furnace, in particular for melting metals.

The invention also relates to a consolidated product obtained from a DVC according to the invention and to a process for manufacturing such a product.

### PRIOR ART

A protective lining is conventionally provided on the inner surface of the heating chamber of furnaces used for melting metals, at least in the portion of this surface in contact with molten metal. In particular, it should have:
good corrosion resistance with respect to molten metal;
good crack resistance;
good resistance to infiltration by molten metal; and
good thermal shock resistance.

For this purpose, use is made of products obtained by thermal consolidation of a pulverulent mixture of DVC type, as described for example in EP 1,224,153.

A DVC is a mix which, unlike a concrete, can be used “dry”, i.e. without adding water or liquid binder, or rarely with a very small amount of water or liquid binder, typically less than 5%, preferably less than 3%, or even less than 2%. This is why, unlike a concrete, a DVC conventionally does not comprise any binder capable of setting via addition of water. The possible teachings which could be drawn from the study of documents relating to concretes cannot therefore, a priori, be transposed to a DVC.

The shaping of a DVC conventionally results from a simple compaction at room temperature (20° C.), the consolidation resulting from a subsequent heat treatment.

Also conventionally, a DVC consists of refractory particles and particles of a heat-activated binder. The temperature of the consolidation heat treatment is between the melting point of the heat-activated binder and that of the refractory particles. During the consolidation heat treatment, the heat-activated binder can thus change from the solid state to a viscous liquid state enabling adhesion to the refractory particles and bonding between the latter. The change from the solid state to this viscous liquid state is referred to as “activation” of the binder. The product thus obtained is referred to as “consolidated product”.

The heat-activated binder is also chosen so as to be able to be in this viscous liquid state at a temperature close to the operating temperature of the furnace, in particular during the first temperature rise. This viscous liquid state thus advantageously makes it possible to reduce the rigidity of the consolidated product, facilitating its deformation and thus increasing its ability to adapt to local thermomechanical stresses. During subsequent temperature rises, the consolidated product can be stiffened by enrichment with fine particles. EP 1 224 153 indicates that a heat-activated binder such as boron oxide or boric acid is preferable because it is effective and inexpensive.

Conventionally, the lining of a furnace is obtained by a process comprising the following successive steps:
a′) preparing a feedstock from a DVC;
b′) shaping said feedstock, in particular by pressing, ramming or vibration, into the form of a layer;
c′) heat treating at least one portion of the shaped feedstock in order
to activate the heat-activated binder in said portion, and thus obtain a consolidated product in said portion,
or, when the temperature reached is sufficient, typically above 1000° C., or even above 1300° C., to decompose the heat-activated binder and sinter, by formation of a direct bond between the refractory particles (by partial melting of the refractory particles) or formation of at least one ceramic binder phase by reacting at least a portion of said refractory particles with one another.

Sintering can result in particular from the temperature in the furnace chamber during use, the heat being supplied by the furnace heating system, or by an additional heat source, for example by an auxiliary burner.

At the end of this process, the lining obtained thus comprises, successively, from a cold face on the opposite side from the hot face in contact with the heated chamber of the furnace:
an unconsolidated back layer, i.e. remaining in the initial powder state, typically representing between 10% and 40% of the thickness of the lining;
a layer consisting of consolidated product and/or sintered product, typically representing between 60% and 90% of the thickness of the lining.

In the latter layer, it is possible to distinguish a highly bonded front layer, which will be exposed to the molten metal, and, behind this front layer, a mechanically weaker intermediate layer having weaker bonding.

However, the intermediate layer is sufficiently bonded to be self-supporting.

If the front layer is sintered, it is substantially devoid of a heat-activated binder, the heat-activated binder having been decomposed. The intermediate layer then conventionally has a structure consolidated by the action of the heat-activated binder, the temperature in this layer not having been high enough to destroy the bonding formed by the heat-activated binder.

The article “Spinel Formation in Coreless Induction Furnace Linings”, Saikia et al, Proceedings of the 4^{th} International Symposium on Advances in Refractories for the Metallurgical Industries, p. 827-840 (2004) describes DVCs based on alumina and/or MgAl₂O₄ spinel. The sintered products obtained from these DVCs exhibit good resistance to corrosion by the molten metals. However they have a limited thermal shock resistance, especially in the case of melting light alloys or aluminum alloys, which cause severe thermal shocks. The thermal shocks create cracks that cause detrimental phenomena of infiltration by the molten metals.

WO 2018/00002068A1 describes a DVC comprising a phosphate binder and a feldspar. The feldspar makes it possible to prepare a non-sintered back layer of sufficient thickness to stop possible infiltrations of molten metal. The presence of feldspar also facilitates the dismantling of the furnace. The binder, preferably of sodium phosphate or potassium phosphate type, makes it possible, in synergy with the feldspar, to improve the resistance to infiltration and wear. The examples produced with this DVC require a quartz feedstock, the fine fraction of which can pose health and safety problems. Tests have furthermore shown that the lining produced with such a DVC gradually erodes in service, which limits its service life. Finally, in the case of repairing the lining, it is difficult to fix the repair material evenly, which affects the service life of the repair.

There is a constant need to improve the service life of a lining of a metal melting furnace, in particular a foundry furnace, more particularly an induction furnace, especially in the case of repairs.

One objective of the invention is to provide a DVC that makes it possible to at least partially satisfy this need.

### SUMMARY OF THE INVENTION

The invention relates to a powder mix, or DVC, intended for the manufacture of a protective lining for a metal foundry furnace, the DVC consisting, for a total of 100% and as percentages by mass based on the mass of the DVC, of:
less than 5% by mass of a liquid, and
a set of particles, the maximum particle size of said set of particles being less than 10 mm, more than 70%, preferably more than 80%, preferably more than 90%, of said particles being made of a refractory material, as a percentage by mass based on said set of particles,
said particles being distributed between
   an aggregate fraction consisting of said particles having a size of greater than or equal to 200 micrometers, referred to as “grains”, more than 90%, preferably more than 95%, preferably more than 99%, preferably 100% of the grains preferably being made of a refractory material, as a percentage by mass based on said grains, and
   a matrix fraction consisting of said particles having a size of less than 200 micrometers, referred to as “fine particles”, representing between 5% and 40% of the mass of said DVC,
the group of the matrix fraction and of said (optional) liquid comprising a heat-activated binder, the heat-activated binder comprising, preferably consisting of, a phosphate chosen from phosphates free of sodium, potassium and lithium, referred to as “non-alkali metal phosphate”, said non-alkali metal phosphate representing more than 0.5%, as percentages by mass based on the mass of the DVC, and
the chemical composition of the group of the matrix fraction and the liquid is such that:

$$0.5 \% < {P}_{2} {O}_{5} < 5 \% and$$

$${Na}_{2} O + {K}_{2} O + {Li}_{2} O < 1. \% ,$$

as percentages by mass based on the mass of the DVC.

The condition P₂O₅<5% indirectly imposes a maximum content of said non-alkali metal phosphate.

As will be seen in greater detail in the remainder of the description, the inventors have discovered that a DVC according to the invention leads to a lining which has an improved service life, including in the case of repairs. In particular, it resists corrosion and thermal shock very well.

The inventors have found, without being able to explain it theoretically, that the intermediate layer, between the front layer and the back layer, had remarkable homogeneity, particularly in terms of mechanical strength and pore size.

In particular, tests carried out by the present inventors have shown that the intermediate layer obtained with the mixture of phosphate binder and feldspar described in WO2018/00002068A1 is much more heterogeneous than that of a consolidated product manufactured under the same conditions (especially under identical vibration or damage conditions and with a single batch of raw materials for refractory particles), but with a DVC according to the invention. The lining obtained according to the teaching of WO2018/00002068A1 erodes more rapidly in service according to the stresses of the furnace in a context where the user seeks a maximum service life. Repairs carried out with a DVC according to the invention are also of better quality, thus prolonging the service life of the furnace. Advantageously, these performances are obtained without it being necessary to add feldspar, which is detrimental to the corrosion resistance.

The specific homogeneity of a consolidated product according to the invention would therefore explain the results obtained.

In a preferred embodiment, more than 90%, more than 95%, preferably more than 99% of the heat-activated binder, as percentage by mass, is in the matrix fraction. Preferably, 100% of the heat-activated binder is in the matrix fraction, i.e. the liquid does not contain any heat-activated binder. Preferably, the composition of the liquid comprises neither P₂O₅, nor Na₂O, nor K₂O nor Li₂O. The content of said liquid, preferably water, is preferably less than 1%, preferably less than 0.5%, as a percentage by mass on the basis of the mass of the DVC.

A DVC according to the invention may further comprise one or more of the following optional features:
the DVC comprises, as a percentage by mass based on the mass of the DVC, less than 5%, preferably less than 4%, preferably less than 3%, preferably less than 2%, preferably less than 1.5%, preferably less than 1%, preferably less than 0.5%, by mass of liquid, which is particularly advantageous to prevent detrimental reactions in foundry furnace applications;
the DVC, preferably said heat-activated binder, comprises less than 5%, less than 3%, preferably less than 1%, preferably less than 0.9%, preferably less than 0.5%, as percentage by mass based on the DVC, preferably does not comprise a phosphate comprising sodium and/or potassium and/or lithium, referred to as “alkali metal phosphate”;
the DVC comprises less than 5%, less than 3%, preferably less than 1%, preferably less than 0.9%, preferably less than 0.5%, preferably comprises no phosphorus-containing heat-activated binder other than said non-alkali metal phosphate, and preferably comprises only said non-alkali metal phosphate as heat-activated binder, as percentages by mass based on the DVC;
said non-alkali metal phosphate is exclusively in particulate form, so that it does not provide liquid;
said non-alkali metal phosphate, preferably the heat-activated binder, is a phosphate, preferably a monophosphate, of at least one element chosen from aluminum, zirconium, calcium, magnesium, strontium, barium, boron, zinc, and copper;
the heat-activated binder is a non-alkali metal monophosphate of an element chosen from aluminum, zirconium, calcium, magnesium, strontium, barium, boron, zinc, and copper;
the matrix fraction comprises, as main constituent, particles made of an oxide of a said element, the heat-activated binder being a non-alkali metal phosphate of said element;
the mass content of free SiO₂ is less than 10%;
preferably, the mass content of feldspar in the heat-activated binder is less than 0.9%, preferably less than 0.5%, preferably less than 0.2%, as a percentage by mass based on the mass of the heat-activated binder, preferably zero; advantageously, the risk of creating a low-melting-point glass is reduced;
preferably, the mass content of feldspar in the DVC is preferably zero; advantageously, the risk of creating a low-melting-point glass is reduced;
more than 90% of said particles and/or fine particles and/or grains are made of a refractory material, as a mass percentage based on said set of particles, fine particles or grains, respectively, said refractory material being chosen from the group formed by alumina, magnesia, chromium oxide, silica, bauxite, mullite, zirconia, partially stabilized zirconia, stabilized zirconia, mullite-zirconia, alumina-zirconia, magnesia-alumina spinel, zircon, cordierite, aluminum titanate, clay chamottes containing between 30% and 50% of alumina, wollastonite, alumina-zirconia-silica materials, alumina-zirconia-silica-chromium oxide materials, bauxite, alumina-reinforced zirconias, alumina-titanium oxide-zirconia materials, and mixtures thereof;
the DVC comprises a consolidation additive chosen from the group formed by borates, in particular fluoroborates, cryolite, fluoride salts, silicate compounds, magnesium chlorides, colemanite, clay, kaolin, amorphous silica, in particular silica fume, phenolic resins, furan resins, ceramic frits, and mixtures thereof;
the matrix fraction comprises a mullite precursor chosen from kyanite, andalusite, clay, and silica in the presence of alumina;
at least 50% by mass of the particles of the aggregate fraction are made of a material identical to that of the particles of the matrix fraction;
the DVC comprises neither hydraulic binder nor temporary organic binder;
the total amount of refractory grains, refractory fine particles, heat-activated binder particles, dust control agent particles and anti-wetting agent particles is greater than 95%, preferably greater than 98%, as percentage by mass based on the mass of the mix.

The invention also relates to a process for manufacturing a consolidated product according to the invention comprising the following successive steps:
a) preparing a feedstock from a DVC according to the invention;
b) shaping said feedstock, in particular by by pressing, ramming or vibration;
c) heat treating at least one portion of the shaped feedstock at a temperature suitable for activating the heat-activated binder, or for sintering the refractory particles (i.e. particles made of a refractory material).

The heat treatment is preferably carried out at a temperature of between 400° C. and 1600° C., preferably between 500° C. and 1500° C.

The invention also relates to a consolidated product in which the refractory particles are bound by said heat-activated binder, and to a sintered product in which the refractory particles are bound by sintering, the consolidated product and the sintered product preferably being obtained by a process according to the invention.

The invention also relates to the use of a consolidated or sintered product according to the invention in an application in which at least one portion of said product is subjected to a service temperature T_{service} lower than the maximum temperature of said heat treatment.

The invention also relates to a metal melting furnace comprising at least one region which at least partly consists of a consolidated product according to the invention and/or of a sintered product according to the invention, in particular produced according to a process according to the invention, in particular, a region intended to be in contact with a molten metal.

The furnace may in particular be a furnace for melting aluminum, aluminum alloys, such as, for example, the reference alloy 42200 according to NF EN 1706, magnesium alloys, zinc alloys or copper alloys.

Of course, the nature of the refractory grains, preferably the nature of the refractory particles of the DVC, is determined in such a way that the melting temperature of said grains, preferably of said particles respectively, is higher than the temperature to which they are intended to be subjected during the manufacture and operation of the furnace.

Finally, the invention relates to a process for manufacturing a furnace, in particular a metal melting furnace, in which a crucible comprising a product according to the invention is manufactured, in particular in a region intended to come into contact with molten metal.

### BRIEF DESCRIPTION OF THE FIGURES

Further features and advantages of the invention will become more clearly apparent on reading the following detailed description and on studying the appended drawing, in which:

FIG. 1 illustrates a mounting on an furnace door used in the examples;

FIG. 2 is a cross-sectional view of an furnace equipped with a door and formwork as described in the examples; and

FIG. 3 illustrates a manufacturing process according to the invention.

This mounting makes it possible to carry out the sintering of a refractory lining under a temperature gradient representative of the operating conditions of a melting furnace. It makes it possible to evaluate the degree of heterogeneity of a lining much finely than in a foundry furnace.

### Definitions

The term “DVC” is understood mean a dry particulate mix, or “pulverulent mix”. The term “dry” is understood to mean that the liquid content is less than 5%. Preferably, the water content, measured by a moisture meter, is less than 1%.
The term “heat-activated binder” is understood to mean a constituent which, under the effect of an increase in temperature, will form a phase capable of binding or agglomerating the particles of a DVC, i.e. capable of leading to a structured (self-supporting) product.
The term “particles” refers to the solid elements of a DVC. The particles of the matrix fraction are referred to as “fine particles” and the particles of the aggregate are are referred to as “grains”.
The “size” of a particle is conventionally given by a particle size distribution characterization. To determine the particle size distribution of a DVC according to the invention, it can be screened through a square-mesh screen suitable for retaining only grains, for example having square meshes of 1 mm. The distribution of the fraction which has passed through the screen can be determined with a laser particle size analyzer. Specifically, a laser particle size analyzer enables the measurement of sizes of less than or equal to 5 mm.
The percentiles or “centiles” 10 (D₁₀), 50 (D₅₀), 90 (D₉₀) and 99.5 (D_{99.5}) of all the particles of a DVC are the particle sizes corresponding to the percentages, by mass, of 10%, 50%, 90% and 99.5% respectively on the cumulative particle size distribution curve of the DVC particles, the particle sizes being classified in ascending order. For example, 10%, by mass, of the particles of the DVC have a size of less than D₁₀ and 90% of the particles by mass have a size of greater than D₁₀. The percentiles can be determined using a particle size distribution produced using a laser particle size analyzer.
The term “maximum size” refers to the percentile 99.5 (D_{99.5}) of the DVC.
The term “median size” refers to the percentile D₅₀, i.e. the size dividing the particles into first and second populations that are equal in mass, these first and second populations comprising only particles having a size greater than, or respectively less than, the median size.
The conventional techniques known to those skilled in the art make it possible to determine the chemical compositions, typically by X-ray fluorescence analysis or by ICP, and the crystallographic compositions, typically by X-ray diffraction analysis.
“Free” silica conventionally denotes a SiO₂ phase, the molecules of which are not associated with other molecules, for example in the form of refractory silicate, in particular zircon or mullite. It may be crystalline silica in the form of quartz for example. The free silica is measured according to well-known methods.
To determine the chemical composition of the matrix fraction, a person skilled in the art knows how to extract, by screening, the undersize at 200 μm on which to perform the abovementioned analyses.
The term “impurities” is understood to mean the inevitable constituents, introduced unintentionally and unavoidably with the raw materials or resulting from reactions with these constituents. The impurities are not constituents that are necessary, but merely constituents that are tolerated. Preferably, the amount by mass of impurities is less than 2%, less than 1%, less than 0.5%, or even substantially zero.
“Refractory material” means a material having a melting temperature above 1500° C. This definition is commonly used by a person skilled in the art and is cited in “Matériaux réfractaires et céramiques techniques: Éléments de Ceramurgie et de Technologie” (Refractory Materials and Technical Ceramics: Elements of Ceramurgy and Technology), G. Aliprandi, published by Septima Paris, 1979. This book also gives, on pages 297 to 301, examples of possible refractory materials, in particular oxides, carbides and nitrides, for a DVC according to the invention. For the present invention, carbon C and silicon carbide SiC are not however considered to be refractory materials.
“Temporary” means “removed from the product during the consolidation heat treatment”.
Unless otherwise indicated, all percentages by mass are expressed relative to the mass of the DVC.
A sum of oxides, for example Na₂O+K₂O+Li₂O, represents the total content of these oxides, but does not mean that each of the oxides is present.
Conventionally, the characteristics relating to a state of the material (melting point, viscosity, etc.) are measured at a pressure of 1 bar, unless otherwise indicated.

### DETAILED DESCRIPTION

### DVC

A DVC consists of a set of particles and optionally a liquid. It preferably comprises less than 5%, preferably less than 4%, preferably less than 3%, preferably less than 2%, preferably less than 1.5%, preferably less than 1%, preferably less than 0.5%, preferably less than 0.1% of liquid, as percentage by mass.

The liquid, and in particular water, conventionally comes from the additives, or even from the heat-activated binder.

In particular, it comprises less than 1%, preferably less than 0.5%, preferably less than 0.1%, of water, as percentage by mass.

Preferably, the set of particles preferably consists of the sole mixture of refractory particles, heat-activated binder particles and, optionally, optional additives, such as a consolidation additive, a dust control agent or an anti-wetting agent.

Preferably, the DVC consists, to more than 95% or even more than 98% or even substantially 100%, of refractory particles, heat-activated binder particles, dust control agent particles and anti-wetting agent particles, the optional balance to 100% consisting of impurities, for example iron from a grinding step, or even traces of moisture.

All refractory particles used according to the prior art can be considered, both for the matrix fraction and for the aggregate fraction. The refractory particles may in particular be made of a fused ceramic product or of a sintered ceramic product.

The nature of the refractory particles is preferably identical in the matrix fraction and in the aggregate fraction.

However, the mass content of free SiO₂ is preferably less than 10%, preferably less than 5%, more preferably less than 2% as percentage by mass based on the DVC, which favors the corrosion resistance to molten metals.

In one embodiment, the DVC comprises more than 0.1% and/or less than 2%, or even less than 1.5%, of potassium fluoroborate (KBF₄). KBF₄ advantageously acts as a consolidation agent for consolidating the material at low temperature.

The impurities preferably represent less than 3%, less than 2% or even less than 1% KBF₄ as percentage by mass based on the DVC. Preferably, the mass content of iron and/or the mass content of titanium is/are less than 2%, preferably less than 1%, preferably less than 0.5%.

Preferably, the DVC does not contain a hydraulic binder or an organic binder except possibly a resin.

In a first embodiment, the DVC contains neither hydraulic binder nor organic binder except possibly a resin; in a second embodiment, the DVC contains neither hydraulic binder nor organic binder.

Preferably, the particle size distribution of a DVC according to the invention is suitable for promoting its compaction. Compaction models such as the Fuller-Bolomey model or the Andreasen model can be used to determine the most suitable particle size distribution.

Preferably, the maximum particle size D_{99.5} of said set of particles is less than or equal to 10 mm, preferably less than or equal to 8 mm, preferably less than or equal to 6 mm, preferably less than 5 mm, preferably less than 4 mm, preferably less than 2 mm, preferably less than 1 mm.

The amount of particles larger than 300 μm is preferably greater than 50% and/or less than 70%, as percentage by mass based on the set of the particles of the DVC.

Preferably, the refractory particles and the heat-activated binder particles together represent more than 81%, more than 85%, more than 90%, more than 93%, or even more than 95%, or even more than 98% of the mass of said DVC.

### Matrix Fraction

Preferably, the matrix fraction represents more than 15%, preferably more than 20%, preferably more than 20% and/or less than 38%, preferably less than 35% of the mass of said set of particles.

The particles smaller than 75 μm preferably represent more than 10% and less than 35% of the mass of said set of particles.

Preferably, more than 80%, preferably more than 90% of the fine particles are made of a refractory material. Preferably, all the fine particles, with the exception of the fine particles of heat-activated binder and the fine particles of optional additive, are refractory particles (i.e. made of a refractory material). The amount of refractory fine particles is preferably greater than 10%, preferably greater than 15%, and/or less than 27%, less than 25%, as percentage by mass based on the DVC.

Said refractory material is chosen from the group formed by alumina, magnesia, chromium oxide, silica, bauxite, mullite, zirconia, partially stabilized zirconia, stabilized zirconia, mullite-zirconia, alumina-zirconia, magnesia-alumina spinel, zircon, cordierite, aluminum titanate, clay chamottes containing between 30% and 50% of alumina, preferably between 35% and 45% of alumina, wollastonite, alumina-zirconia-silica (or “AZS”) materials, alumina-zirconia-silica-chromium oxide (or “AZS-Cr”) materials, bauxite, alumina-reinforced zirconias, alumina-titanium oxide-zirconia materials, and mixtures thereof.

Preferably, said refractory material is chosen from the group formed by alumina, mullite, clay chamottes containing between 30% and 50% alumina, preferably between 35% and 45% alumina, bauxite, and mixtures thereof. More preferably, said refractory material is chosen from the group formed by alumina, mullite, and mixtures thereof.

Preferably, the mass content of Al₂O₃ in the matrix fraction is greater than 50%.

Preferably, the mass content of P₂O₅ in the matrix fraction is greater than 0.5%, preferably greater than 1%, and/or less than 15%, preferably less than 10%, preferably less than 5%, more preferably less than 4%.

More preferably, the P₂O₅/(Al₂O₃+ZrO₂+CaO+MgO+SrO+BaO) mass ratio in the matrix fraction is greater than 5%, preferably greater than 5.5% and/or less than 10%, preferably less than 7.5%.

In a particularly advantageous embodiment, the matrix fraction comprises, relative to the mass of the DVC, more than 0.1%, preferably more than 0.5%, more preferably more than 1%, or even more than 2% and/or less than 20%, preferably less than 15%, more preferably less than 10%, or even less than 5% of a mullite precursor chosen from kyanite, preferably crude kyanite, andalusite, clay, silica in the presence of alumina. With said non-alkali metal phosphate, preferably the phosphate of a single non-alkali metal element, such a precursor makes it possible, after heat treatment for consolidating the DVC, to obtain a binder phase that is even better distributed in the consolidated product, in particular in said intermediate layer. Preferably, the P₂O₅/(Al₂O₃+SiO₂) mass ratio in the matrix fraction is between 0.05 and 0.25, preferably between 0.05 and 0.15, or less than 0.10 or less than 0.08.

### Heat-Activated Binder

The DVC comprises more than 0.5%, preferably more than 1%, more than 1.5%, more than 1.8%, and less than 20%, preferably less than 10%, less than 5%, less than 4%, less than 3%, or even less than 2.5% of non-alkali metal phosphate, as percentage by mass based on the DVC.

The DVC comprises more than 0.5%, preferably more than 1%, more than 1.5%, more than 1.8%, and less than 20%, preferably less than 10%, less than 5%, less than 3%, or even less than 2.5% of heat-activated binder, as percentage by mass based on the DVC.

Preferably, the non-alkali metal phosphate, preferably the heat-activated binder, has a loss on ignition, measured at 900° C., of less than 20%.

The non-alkali metal phosphate, preferably the heat-activated binder, may be liquid or solid, preferably solid, in particulate form. Preferably, the non-alkali metal phosphate, preferably the heat-activated binder, is in the form of a powder of particles, preferably of fine particles, that is to say a powder with a median particle diameter of less than 200 micrometers.

The aggregate fraction comprises less than 20%, less than 10% or even less than 5% of particles of said heat-activated binder, referred to as “binder grains”, as a percentage by mass based on the total amount of heat-activated binder, or even substantially no binder grains.

Preferably, the amount of fine particles of non-alkali metal phosphate, preferably of heat-activated binder, is preferably greater than 1%, greater than 1.5%, and/or preferably less than 5%, preferably less than 4%, or even less than 3.5%, as percentage by mass based on the DVC.

According to the invention, the non-alkali metal phosphate preferably consists of a phosphate of at least one non-alkali metal element, preferably chosen from aluminum, zirconium, calcium, magnesium, strontium, barium, boron, zinc and copper, preferably chosen from aluminum, zirconium, calcium, magnesium and strontium. Said non-alkali metal phosphate preferably comprises a monophosphate of said element (among those mentioned above), i.e. the phosphate chains are independent, i.e. not bonded to one another.

In one embodiment, the matrix fraction comprises, as the main constituent, i.e. the constituent with the highest mass content, particles of an oxide of an element, and the heat-activated binder comprises, preferably is, a phosphate, preferably a monophosphate, of said element. For example, if the matrix fraction consists predominantly (i.e. for more than 50% by mass) of particles of alumina and/or of a mineral compound predominantly containing the element aluminum (excluding oxygen), such as mullite or kyanite for example, the heat-activated binder is preferably aluminum phosphate, preferably aluminum monophosphate.

### Additives

The DVC may contain a consolidation additive, in particular depending on the operating temperature of the furnace (temperature during its operation). As an example, use may be made of cryolite for an application in which the operating temperature is above 950° C.

The content of consolidation additive is preferably greater than 0.1%, preferably greater than 0.3%, more preferably greater than 0.5% and/or less than 1.5%, preferably less than 1.3%, preferably less than 1.1%, as percentage by mass based on the DVC.

Preferably, it has a particulate form and preferably it consists of more than 90%, more than 95%, preferably substantially 100% by mass of fine particles.

The consolidation additive is chosen so as to have a lower melting point than that of the refractory particles. During the consolidation heat treatment, the heat-activated binder can thus form a refractory particle-binding phase at a lower temperature.

The consolidation additive is preferably chosen from the group formed by cryolite, borates, in particular fluoroborate, more particularly potassium fluoroborate, fluoride salts, silicate compounds, magnesium chlorides, colemanite, clay, kaolin, amorphous silica, in particular silica fume, resins, ceramic frits, and mixtures thereof.

Preferably, the consolidation additive comprises a resin chosen from phenolic resins, furan resins, acrylic resins, polyester resins, epoxy resins, silicone resins, siloxane resins, alkyd resins, polyvinyl resins, and mixtures thereof. In a particular embodiment, the resin is chosen from particulate products which can be converted into a polymer during the consolidation heat treatment.

The DVC preferably contains a dust control agent for reducing or even eliminating dust during the installation of the DVC. The dust control agent is preferably selected from the group formed by oils, in particular mineral oils, kerosene, organic polymers and mixtures thereof. Preferably, the dust control agent is kerosene.

Preferably, the amount of dust control agent is between 0.1% and 1%, as percentage by mass based on the DVC.

The DVC preferably contains an “anti-wetting” agent for reducing wettability with respect to molten metals of the sintered product and/or the consolidated product obtained from the DVC. Preferably, the anti-wetting agent is chosen from silicon carbide, barium sulfate, SiAION and nitrides. Preferably, the anti-wetting agent is chosen from silicon carbide and barium sulfate. More preferably, the anti-wetting agent is barium sulfate.

Preferably, the anti-wetting agent is introduced in the form of particles having a size less than or equal to 100 μm.

Preferably, the amount of anti-wetting agent is between 3% and 15%, preferably between 4% and 10%, as percentage by mass based on the DVC.

### Aggregate Fraction

Preferably more than 80%, preferably more than 90%, preferably more than 95%, preferably substantially 100% of the particles of the aggregate fraction, referred to as “grains”, are made of a refractory material.

Preferably more than 50%, more than 70%, more than 90%, more than 95%, even substantially 100% by mass of the refractory grains (i.e. grains made of a refractory material) are made of a material identical to that of the refractory particles of the matrix fraction.

The refractory grains are preferably made of a material chosen from the group formed by alumina, magnesia, chromium oxide, silica, bauxite, mullite, zirconia, partially stabilized zirconia, stabilized zirconia, mullite-zirconia, alumina-zirconia, magnesia-alumina spinel, zircon, cordierite, aluminum titanate, clay chamottes containing between 30% and 50% of alumina, preferably between 35% and 45% of alumina, wollastonite, alumina-zirconia-silica (or “AZS”) materials, alumina-zirconia-silica-chromium oxide (or “AZS-Cr”) materials, bauxite, alumina-reinforced zirconias, alumina-titanium oxide-zirconia materials, and mixtures thereof. Preferably, the refractory grains are made of a material chosen from the group formed by alumina, mullite, clay chamottes containing between 30% and 50% alumina, preferably between 35% and 45% alumina, bauxite, and mixtures thereof. More preferably, the refractory grains are made of a material chosen from the group formed by alumina, mullite, and mixtures thereof.

Preferably, at least 50% by mass of the particles of the aggregate fraction consists of alumina (Al₂O₃).

### Process for Manufacturing the DVC

A DVC according to the invention can be manufactured by simply mixing of raw materials with suitable particle sizes, crystallizations and compositions.

### Process for Manufacturing the Product According to the Invention

The process for manufacturing the product comprises the abovementioned steps a) to c).

This process is described below, in a non-limiting manner, for the manufacture of a lining of the side wall and/or the bottom of a crucible, in particular of a crucible of an induction furnace.

In step a), a feedstock is prepared with a DVC according to the invention.

Preferably, in step a), no water or temporary binder is added to the DVC, in order to limit the creation of porosity during step c).

Preferably, the DVC is used as is, i.e. step a) is optional, the feedstock being the DVC.

In step b), the feedstock is shaped.

The bottom of the crucible, or “hearth”, is conventionally produced by pouring the feedstock, preferably consisting of a DVC according to the invention, onto the floor of the furnace chamber. The layer thus formed is then compacted.

All known means for compacting a DVC according to the invention are possible, in particular pressing, ramming, casting or vibration.

Preferably, the compacted DVC is then levelled. This levelling also makes it possible to remove the upper part of the rammed or vibrated layer, which is more weakly densified. A mold for manufacturing the side wall is then provisionally placed on the levelled layer.

In order to produce the side wall of the crucible, feedstock is then between the furnace chamber, for example constituted of insulating materials, and the mold placed in said chamber, preferably until the feedstock surrounds the mold over its entire height.

Preferably, the feedstock is compacted by vibration. The compaction may be carried out as the feedstock is poured.

In step c), a temperature rise enables activation of the heat-activated binder, and thus makes it possible to form a phase binding the refractory particles together, so as to obtain a “consolidated” product according to the invention.

The heat treatment can lead to total or partial sintering of the refractory particles of the DVC, so as to obtain a “sintered” product according to the invention in which said binder phase has been decomposed.

The heat treatment is preferably carried out at a temperature above the operating temperature T_{operating} at which the furnace operates in use. The duration of the hold at the maximum temperature reached during the heat treatment is preferably greater than 30 minutes, preferably greater than 1 hour and/or less than 10 hours, preferably less than 3 hours.

The consolidated product, which is consolidated by activation of the heat-activated binder, or sintered product obtained at the end of step c) typically has an open porosity of between 10% and 30%, preferably between 15% and 25%.

In step c), the activation temperature is not always reached over the entire thickness of the DVC intended for the side wall and bottom of the crucible, so that part of the crucible, especially in the vicinity of the furnace inductor, may not be consolidated or sintered (back layer).

The furnace may thus comprise a lining comprising, successively, from the cold face on the opposite side from the hot face in contact with the heated chamber of the furnace:
an unconsolidated back layer, remaining in the initial powder state, representing between 10% and 40% of the thickness of the lining;
a layer consisting of consolidated product and/or sintered product, representing between 60% and 90% of the thickness of the lining.

The latter layer preferably consists of:
a front layer (which will be exposed to the molten metal) which is strongly bonded, or even sintered and substantially free of heat-activated binder, and
an intermediate layer, located behind this front layer in relation to the molten metal, which has weaker bonding and is mechanically weaker, sufficiently bonded to be self-supporting, within which the temperature has not been high enough to destroy the bonding formed by the heat-activated binder.

Preferably after the heat treatment step, the mold is removed or disposed of and the crucible is ready to be used for metal melting. According to one possible embodiment, the mold or formwork is removed after shaping the powder.

### EXAMPLES

The invention is not limited to the described embodiments provided by way of examples and described below.

### Preparation of the DVCs

The following refractory particle powders and additives were used:
3-5 mm grade sintered mullite powder comprising 70-73% Al₂O₃ and 22-27% SiO₂;
1-3 mm grade sintered mullite powder comprising 70-73% Al₂O₃ and 22-27% SiO₂;
0-1 mm grade sintered mullite powder comprising 70-73% Al₂O₃ and 22-27% SiO₂;
0-0.09 mm grade sintered mullite powder comprising 70-73% Al₂O₃ and 22-27% SiO₂;
calcined alumina powder with a median size of about 4.5 μm and having an alumina content of greater than 99%;
crude kyanite powder KYANITE®-100 mesh;
boric acid in powder form having an H₃BO₃ equivalent of greater than 99.9% and a median size D₅₀ equal to 100 μm;
a potassium fluoroborate powder typically containing 96% by mass of KBF₄ and having a size of less than 100 μm.

The various particulate raw materials were introduced into a mixer and dry blended for 5 minutes.
For comparative example 1, the refractory powders of mullite, crude kyanite and calcined alumina were mixed in proportions suitable for obtaining the mineral chemical composition presented in table 1. The heat-activated binder is boric acid powder to which potassium tetrafluoroborate has been added.
Comparative example 2 was manufactured as in example 1, but the heat-activated binder was potassium dihydrogen orthophosphate in the form of a powder of FFB393® brand supplied by Budenheim such as the one used in WO2018/002068A1.
Example 3 according to the invention was manufactured as in example 1, but the heat-activated binder was an aluminum monophosphate powder of FFB716® brand, also supplied by Budenheim.
Comparative example 4 was manufactured as in example 3 according to the invention but without the aluminum monophosphate powder of FFB716® brand.
Comparative example 5 was manufactured as in example 3 according to the invention but with a content of aluminum monophosphate of FFB716® brand that is twice as high.

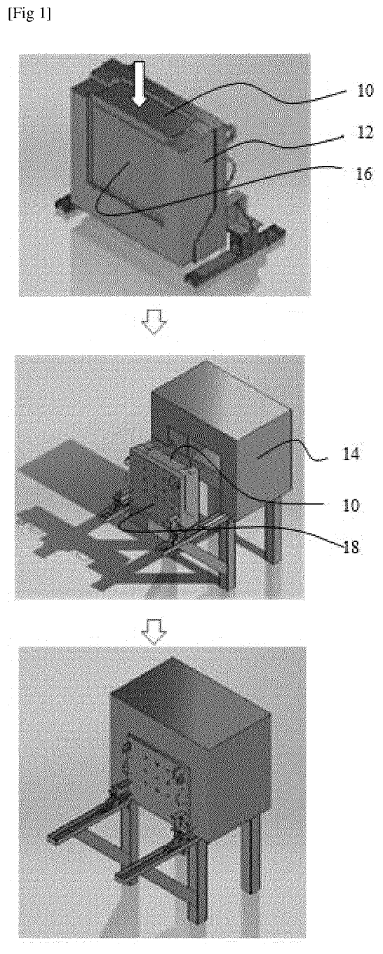

For each example, as illustrated in FIG. 1, the DVC 10 was compacted by vibration (vertical arrow in the first diagram of FIG. 1) in an aluminous refractory concrete formwork 12 to which a silicon carbide plate 16 was added on the side intended to be exposed to the interior of the furnace 14 in order to facilitate thermal conduction. The formwork had the following internal dimensions: length 445 mm, height 425 mm and thickness 150 mm.

All the examples contained less than 1% by mass of water.

### Furnace Door Test

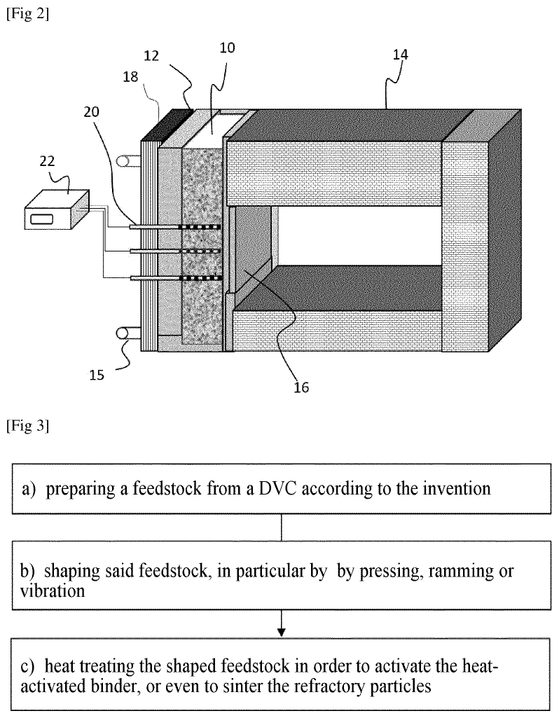

In order to stress a DVC under a temperature gradient, the formwork containing the compacted DVC was fixed to the door 18 of a laboratory furnace 14 equipped with a cooling device 15 (FIG. 2). Thermocouples 20 connected to a measuring device 22 were also arranged every 2 cm in the thickness direction in order to follow the change in temperature in various regions of the compacted DVC, in the thickness direction (from the hot face (on the resistance heating side of the furnace) to the cold face). The door 18 was then closed so that the compacted DVC is placed opposite vertical electrical resistance heating elements of the furnace. Then the temperature inside the furnace was increased to a hold temperature of 1500° C., with a ramp of 150° C./h. A temperature gradient then appears between the hot face of the compacted DVC exposed to the electrical resistance heating elements and the opposite cold face, on the side of the door cooled by water to 25° C. (see FIG. 2).

The furnace was maintained at the hold temperature for 48 hours. The temperature was then reduced, at a rate of less than 200° C./h, to room temperature (20° C.).

The formwork was then dismantled and test specimens of the consolidated material obtained were extracted in order to characterize regions of this material which had been subjected, during the hold, to temperatures
below 400° C., the corresponding region being considered as the back layer,
between 400° C. and 800° C. and between 800° C. and 1200° C., the corresponding region being considered as the intermediate layer, and
above 1200° C., the corresponding region being considered as the front layer (defining the hot face).

### Characterization

The characterized DVCs did not contain water.

The particle size distribution of the DVCs before shaping can be determined as described in the “Definitions” section above.

The chemical analysis is determined by X-ray fluorescence spectroscopy for elements with a content of greater than 0.1% by mass. If the content of an element is less than 0.1% by mass, it is determined by ICP (Induction Coupled Plasma), on a Vista AX model (sold by Varian).

The bulk density and the open porosity after consolidation heat treatment are measured according to the following method:

Test specimens in the form of bars with a length of 100 mm and a square cross-section with a width of 20 mm were taken from the various layers of the consolidated product obtained after heat treatment. They are first dried at 110° C. and then weighed to determine their dry mass Ms. They are then placed in a bell jar under an air vacuum for 30 minutes. The bell jar is then filled with water, so that the test specimens are completely immersed. After immersion, the vacuum is maintained for 30 minutes. Atmospheric pressure is then restored in the bell jar and allowed to stand again for 30 minutes. The test specimens are then subjected to hydrostatic weighing, giving a mass Mi. They are then wiped with a moist cloth and their moist mass Mh is measured. The bulk density is given by the ratio ρ·Ms/(Mh−Mi), in g/cm³, p being the density of water, taken as equal to 1 g/cm³. The open porosity is given by the ratio 100(Mh−Ms)/(Mh−Mi), in %.

The cold compressive strength was measured, according to standard EN 993-5, on cylindrical test specimens of the consolidated product, 30 mm in height and 30 mm in diameter, previously oven-dried at 110° C. for 12 hours.

The median pore diameter was measured using a mercury porosimeter according to standard ISO 15901-1.2005 Part 1.

The degree of heterogeneity in the intermediate layer between 400° C. and 1200° C. was evaluated by visual observation of the appearance of the material and in particular of its macroscopic structure. A score between H0 (maximum homogeneity) and H4 (maximum heterogeneity) was assigned.

### Results

Table 1 below describes the mixes. Table 2 summarizes the results obtained.

TABLE 1

| Example | | 1* | 2* | 3 | 4* | 5* |
|---|---|---|---|---|---|---|
| Composition of the DVC (mass percentages based on the DVC) | | | | | | |
| Sintered mullite | 3-5 mm | 21 | 21 | 21 | 21 | 21 |
| Sintered mullite | 1-3 mm | 26 | 26 | 26 | 26 | 26 |
| Sintered mullite | 0-1 mm | 33 | 33 | 33 | 33 | 33 |
| Sintered mullite | 0-0.09 mm | 7 | 7 | 7 | 7 | 7 |

| Fine particles of calcined alumina | 6 | 6 | 6 | 6 | 6 |
|---|---|---|---|---|---|
| Fine particles of kyanite | 4 | 4 | 4 | 4 | 4 |
| Boric acid | 2 | 0 | 0 | 0 | 0 |
| Potassium tetrafluoroborate | 1 | 1 | 1 | 1 | 1 |
| FFB393 ® with a loss on ignition of 13% at 900° C. | 0 | 2 | 0 | 0 | 0 |
| FFB716 ® with a loss on ignition of 17% at 900° C. | 0 | 0 | 2 | 0 | 4 |
| Characterization of the DVC before shaping (mass percentages based on the DVC) | | | | | |
| Aggregate fraction | 67 | 67 | 67 | 67 | 67 |
| Matrix fraction | 33 | 33 | 33 | 33 | 33 |
| Mass content of free SiO₂ in the DVC | <2 | <2 | <2 | <2 | <2 |
| Mass content of Al₂O₃ ** | 20 | 20 | 20 | 22 | 20.8 |
| Mass content of ZrO₂ ** | <0.1 | <0.1 | <0.1 | <0.1 | <0.1 |
| Mass content of CaO ** | 0.4 | 0.4 | 0.4 | 0.4 | 0.4 |
| Mass content of MgO ** | 0.1 | 0.1 | 0.1 | 0.1 | 0.1 |
| Mass content of SrO ** | <0.1 | <0.1 | <0.1 | <0.1 | <0.1 |
| Mass content of BaO ** | <0.1 | <0.1 | <0.1 | <0.1 | <0.1 |
| Mass content of SiO₂ ** | 18 | 18 | 18 | 18 | 18 |
| Mass content of P₂O₅ ** | <0.5 | 1.0 | 1.3 | <0.5 | 2.6 |
| Mass content of (Na₂O + K₂O + Li₂O) ** | <0.7 | 1.2 | <0.8 | <0.8 | 0.5 |
| Mass ratio of | <0.5 | 4.9 | 6.3 | <0.5 | 12.2 |
| P₂O₅/(Al₂O₃ + ZrO₂ + CaO + MgO + SrO + BaO) | | | | | |

TABLE 2

| | | | | | |
|---|---|---|---|---|---|
| Example | 1* | 2* | 3 | 4* | 5* |

Properties of the product after door test
Back layer (unconsolidated area) (<400° C.)

| Thickness, in mm | 8 | 15 | 17 | 58 | N.ME. |
|---|---|---|---|---|---|
| Bulk density (g/cm³) | <2.0 | <2.0 | <2.0 | <2.0 | N.ME. |
| Open porosity (%) | N.M. | N.M. | N.M. | N.M. | N.M. |
| Median pore diameter (μm) | N.M. | N.M. | N.M. | N.M. | N.M. |
| Compressive strength (MPa) | N.M. | N.M. | N.M. | N.M. | N.M. |
| Intermediate layer, first part | 400° C.-800° C. | | | | 500° C. |
| Bulk density (g/cm³) | 2.31 | 2.29 | 2.32 | 2.21 | 2.38 |
| Open porosity (%) | 24.6 | 26.0 | 24.5 | 30.1 | 22.5 |
| Median pore diameter (μm) | 4.8 | N.M. | 6.5 | 10.2 | N.ME. |
| Compressive strength (MPa) | 2 | 5 | 7 | 1 | 15 |
| Intermediate layer, second part | 800° C.-1200° C. | | | | 1000° C. |
| Bulk density (g/cm³) | 2.29 | 2.33 | 2.34 | 2.38 | 2.36 |
| Open porosity (%) | 25.2 | 23.9 | 23.5 | 23.6 | 22.2 |
| Median pore diameter (μm) | 3.1 | N.M. | 7.6 | 4.0 | N.ME. |
| Compressive strength (MPa) | 11 | 10 | 13 | N.ME. | 16 |
| Homogeneity in the intermediate layer | H2 | H3 | H1 | H4 | N.ME. |
| Front layer (>1200° C.) | | | | | 1400° C. |
| Bulk density (g/cm³) | 2.26 | 2.33 | 2.35 | 2.36 | 2.33 |
| Open porosity (%) | 26.8 | 23.5 | 23.4 | 24.5 | 23.3 |
| Median pore diameter (μm) | 8.9 | N.M. | 7.3 | 3.5 | N.ME. |
| Compressive strength (MPa) | 15 | 15 | 16 | 17 | 18 |

*outside the invention; N.M.=not measurable (powdery appearance); N.ME.=not measured; ** as a percentage, in the matrix fraction

As is now clearly apparent, a DVC according to the invention leads to a remarkable homogeneity in the intermediate layer. In particular, a comparison of example 3 according to the invention with comparative example 2 shows that the addition of a non-alkali metal phosphate additive, in particular a non-alkali metal monophosphate, makes it possible to obtain a more homogeneous intermediate layer and properties that are more uniform and relatively closer to those of the front layer. A lining obtained from a DVC according to the invention thus has a more predictable behavior as the lining becomes worn via its hot face.

Comparison of example 3 according to the invention with comparative example 4 shows the advantage of using the non-alkali metal phosphate in combination with a mullite precursor such as, for example, kyanite. Indeed, the mixture of example 4 comprising only kyanite without non-alkali metal phosphate has very good properties in the front layer and part of the intermediate layer. But the intermediate layer is very heterogeneous, which in service means a shorter service life for the consolidated lining.

Moreover, example 3 according to the invention has a less porous structure in its front layer compared with comparative example 1.

In addition, example 5, with a P₂O₅/(Al₂O₃+ZrO₂+CaO+MgO+SrO+BaO) mass ratio in the matrix fraction of greater than 10%, has a mechanical strength, in the intermediate layer exposed to 500° C., which is considered to be too high, liable to create stresses in the refractory lining.

Finally, the consolidated product obtained from a DVC according to the invention has good mechanical properties and a stable microstructure between 500° C. and 1000° C., i.e. the temperature range to which it is subjected when the furnace is started in the intermediate layer.

1. A powder mix intended for the manufacture of a protective lining for a metal foundry furnace, the mix comprising, for a total of 100% and as percentages by mass based on the mass of the mix, of:
less than 1% by mass of water, and
a set of particles, the maximum particle size of said set of particles being less than 10 mm, more than 70% of said particles being of a refractory material, as a percentage by mass based on said set of particles,
said particles being distributed between
an aggregate fraction including said particles having a size of greater than or equal to 200 micrometers, referred to as “grains”, and
a matrix fraction including said particles having a size of less than 200 micrometers, referred to as “fine particles”, representing between 5% and 40% of the mass of said mix,
the group of the matrix fraction and of said liquid comprising a heat-activated binder, the heat-activated binder comprising a phosphate chosen from phosphates free of sodium, potassium, and lithium, referred to as “non-alkali metal phosphate”, said non-alkali metal phosphate representing more than 0.5%, as percentages by mass based on the mass of the DVC,
the chemical composition of the group of the matrix fraction and the liquid is such that:
$$0.5 \% < {P}_{2} {O}_{5} < 5 \% and$$
$${Na}_{2} O + {K}_{2} O + {Li}_{2} O < 1. \% ,$$
as percentages by mass based on the mass of said mix, and
the P₂O₅/(Al₂O₃+ZrO₂+CaO+MgO+SrO+BaO) mass ratio in the matrix fraction is greater than 5% and less than 10%.

2. The mix as claimed in claim 1, wherein the non-alkali metal phosphate, preferably the heat-activated binder, is a phosphate of at least one element chosen from aluminum, zirconium, calcium, magnesium, strontium, barium, boron, zinc, and copper.

3. The mix as claimed in claim 1, wherein the non-alkali metal phosphate, preferably the heat-activated binder, is a monophosphate of an element chosen from aluminum, zirconium, calcium, magnesium, strontium, barium, boron, zinc, and copper.

4. The mix as claimed in claim 2, wherein the matrix fraction comprises, as a main component, particles of an oxide of a said element, and wherein the non-alkali metal phosphate is a phosphate of said element.

5. The mix as claimed in claim 1, wherein the mass content of free SiO₂ is less than 10%.

6. The mix as claimed in claim 1, wherein more than 90% of said particles and/or fine particles and/or grains are made of a refractory material, as a mass percentage based on said set of particles, fine particles or grains, respectively, said refractory material being chosen from the group formed by alumina, magnesia, chromium oxide, silica, bauxite, mullite, zirconia, partially stabilized zirconia, stabilized zirconia, mullite-zirconia, alumina-zirconia, magnesia-alumina spinel, zircon, cordierite, aluminum titanate, clay chamottes containing between 30% and 50% of alumina, wollastonite, alumina-zirconia-silica materials, alumina-zirconia-silica-chromium oxide materials, bauxite, alumina-reinforced zirconias, alumina-titanium oxide-zirconia materials, and mixtures thereof.

7. The mix as claimed in claim 1, comprising a consolidation additive chosen from the group formed by borates, in particular fluoroborates, cryolite, fluoride salts, silicate compounds, magnesium chlorides, colemanite, clay, kaolin, amorphous silica, in particular silica fume, phenolic resins, furan resins, ceramic frits, and mixtures thereof.

8. The mix as claimed in claim 1, wherein the matrix fraction comprises a mullite precursor chosen from kyanite, andalusite, clay, and silica in the presence of alumina.

9. The mix as claimed in claim 1, wherein at least 50% by mass of the particles of the aggregate fraction are made of a material identical to that of the particles of the matrix fraction.

10. The mix as claimed in claim 1, comprising neither hydraulic binder nor temporary organic binder.

11. The mix as claimed in claim 1, wherein the total amount of refractory grains, refractory fine particles, heat-activated binder particles, dust control agent particles and anti-wetting agent particles is greater than 95%, as percentage by mass based on the mass of the mix.

12. The mix as claimed in claim 1, wherein said non-alkali metal phosphate is in the matrix fraction, the chemical composition of the matrix fraction being such that
$$0.5 \% < {P}_{2} {O}_{5} < 5 \% and$$
$${Na}_{2} O + {K}_{2} O + {Li}_{2} O < 1. \% ,$$
as percentages by mass based on the mass of said mix.

13. The mix as claimed in claim 1, wherein the non-alkali metal phosphate is in particulate form.

14. The mix as claimed in claim 1, wherein the heat-activated binder does not comprise feldspar and/or comprises less than 1% of a phosphate comprising sodium and/or potassium and/or lithium, as percentage by mass based on the mix.

15. A process for manufacturing a consolidated product comprising the following successive steps:
b) compacting a mix according to claim 1; and
c) heat treating at least one portion of the shaped feedstock at a temperature suitable for activating the heat-activated binder, or for sintering the particles made of a refractory material.

16. A metal melting furnace comprising at least one region intended to be in contact with a molten metal, said region being constituted, at least in part, of a consolidated product and/or of a sintered product produced according to a process as claimed in claim 15.

17. The furnace as claimed in claim 16, comprising a lining comprising, successively, from a cold face on the opposite side from the hot face in contact with the heated chamber of the furnace:
an unconsolidated back layer, remaining in the initial powder state, representing between 10% and 40% of the thickness of the lining; and
a layer consisting of consolidated product and/or sintered product, representing between 60% and 90% of the thickness of the lining.
